(19) United States
(12) Patent Application Publication
(10) Pub. No.: US 2005/0195853 A1
(43) Pub. Date: Sep. 8, 2005

(54) Telephone device capable of reading phonebook of a portable electronic product and method thereof

(76) Inventors: Jao-Ching Lin, Hsin Chuang (TW); Tien-shun Ma, Hsin Chuang (TW)

Correspondence Address: Ann Tsai, Suite 137, PmB 174, 931 West 75th Street, Naperville, IL, 60565, US

(21) Appl. No.: 10/792,714

(22) Filed: Mar. 5, 2004

(51) Int. Cl. H04L 12/66

(52) U.S. Cl. 370/463; 370/412

(57) ABSTRACT

A telephone device capable of reading phonebook of a portable electronic product is electrically connected to a power source and the portable electronic product. The telephone device includes a main body, a display module, a calling and receiving unit for receiving and sending voice message. The main body further mounted with a controller, a memory module and a first transmission interface. The controller is electrically connected to the calling and receiving unit and the display module respectively. The memory module is electrically connected to the controller and the first transmission interface is electrically connected to the controller. It is characterized in that the controller receives phonebook data of the portable electronic product via the first interface, stores the phonebook data in the memory module and displays status of the phonebook data via the display module.

### BACKGROUND OF THE INVENTION

1. Field of the Invention

The present invention is related to a telephone device and a method for reading phonebook and particularly to a telephone device capable of reading phonebook of a portable electronic product and method thereof.

2. Brief Description of Related Art

Presently, many people have portable electronic products such as personal digital assistant (PDA), cell phone and etc. in addition to ordinary home telephone set. Generally speaking, frequently used phonebook data is usually recorded and stored in the portable electronic products.

Taking the cell phone as an example, the portable electronic product is an electronic device being carried about so that it is very convenient that the phonebook data can be found whenever phone calls are going to be dialed easily. However, there is a doubt of electromagnetic wave hurting human body health while the cell phone is in use especially the long distant call. Besides, calling with the cell phone is more expensive than phone calls between ordinary telephone sets so that the ordinary telephone lines still widely used due to consideration of health and cost.

Although some brands of the telephone sets furnish memory function for 10 or 20 telephone numbers, it is insufficient for more family members. Because the portable electronic product has been popularly used, it is very common that the frequently used telephone numbers are stored in the portable electronic product instead of being stored in the ordinary telephone set. How to read the phonebook in the portable electronic product with the ordinary telephone set is a key of the present invention.

### SUMMARY OF THE INVENTION

Accordingly, an object of the present invention is to provide a telephone device capable of reading phonebook data of a portable electronic product for the user being able to have a more humanized operation.

Another object of the present invention is to provide a telephone device, which is able to recharge a portable electronic product.

A further object of the present invention is to provide a telephone device with touch dialing instead of traditional press dialing.

A further object of the present invention is to provide a method for reading phone book data of a portable electronic product.

The telephone device of the present invention is electrically connected to a power source and a portable electronic product with phonebook data therein and includes a main body, a display module and a calling and receiving unit for receiving and sending voice message. The main body provides at the inside thereof a controller electrically connected to the calling and receiving unit and the display module, a memory module electrically connected to the controller and a first transmission interface electrically connected to the controller. The controller receives phonebook data of the portable electronic product via the first interface, stores the phonebook data in the memory module and displays status of the phonebook data via the display module.

In order to perform recharging the portable electronic product, the telephone device of the present invention further includes a recharging module and a second transmission interface. The charging module is electrically connected to the power source and the controller. The second transmission interface is electrically connected to the controller and the portable electronic product. The power supplied by the charging module, which is utilized by the controller, charges the portable electronic product via the second transmission interface.

Besides, in order to allow the telephone device of the present invention providing touch dial instead of press dial, the telephone device has a touch module mounted to the main body with a plurality of digital buttons arranged in different block zones to perform the ordinary dialing function via the digital buttons being touched.

A method for reading phonebook of a portable electronic product according to the present invention provides a telephone device, which is electrically connected to the portable electronic product and has a preset password stored therein. The method includes electrically connecting the telephone device to the portable electronic product, inputting a password and checking if the password being coincided with the preset password, to execute downloading phonebook data of the portable electronic product to the telephone device in case of the input password coinciding the preset password, prompting the user repeatedly in case of the input password not coinciding the preset password and disconnecting transmission of the phonebook data in case of the downloading being complete and the password being input over three times and password not coinciding the preset password.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view illustrating a preferred embodiment of a telephone device capable of reading phonebook of a portable electronic product according to the present invention;

FIG. 2 is a block diagram illustrating the telephone device of the preferred embodiment shown in FIG. 1 with a conventional portable electronic product and a power supply downloading phonebook data of the portable electronic product via a first transmission interface and recharging the portable electronic product via a second transmission interface;

FIG. 3 is a perspective view illustrating the telephone device of the preferred embodiment shown in FIG. 1 with the conventional portable electronic product and the power supply to download the phonebook data by way of infrared transmission;

FIG. 4 is a perspective view illustrating the telephone device of the preferred embodiment electrically connecting with the conventional portable electronic product via the second transmission interface;

FIG. 5 is a perspective view illustrating a second preferred embodiment of a telephone device capable of reading phonebook of a portable electronic product according to the present invention downloading the phonebook data of the conventional portable electronic product by way of USB transmission; and

FIG. 6 is a flow chart illustrating a method for reading phonebook of a portable electronic product according to the present invention.

### DETAILED DESCRIPTION OF THE PREFERRED EMBODIMENT

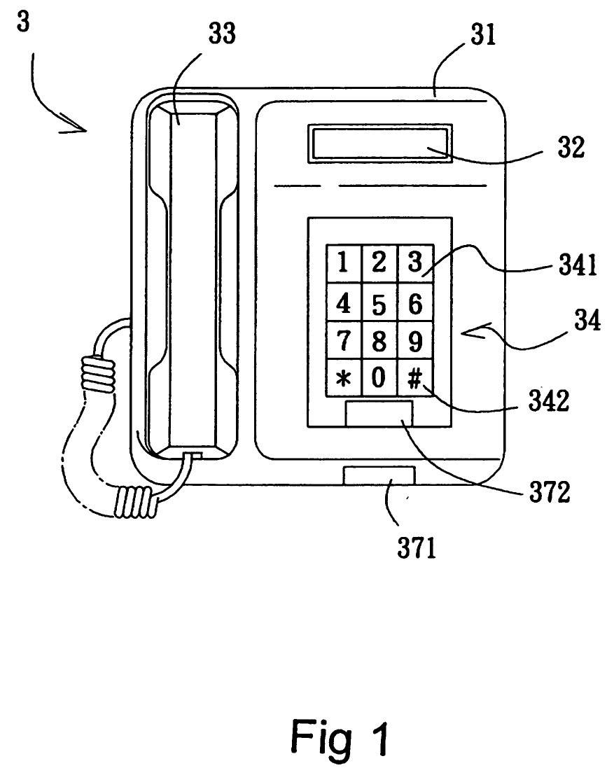

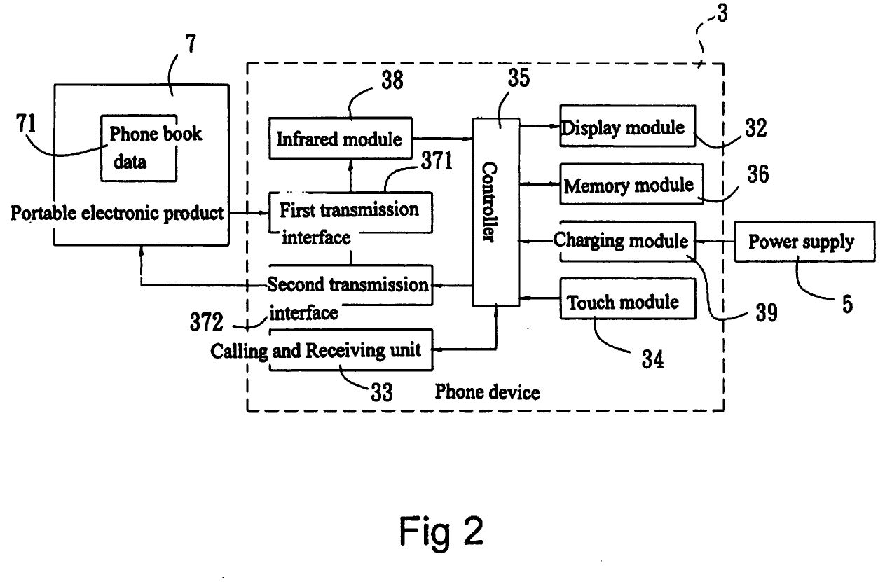

Referring to FIGS. 1 and 2, a telephone device capable of reading phone book of a portable electronic product according to the present invention in the first embodiment thereof includes a main body 31, a display module 32, a calling and receiving unit 33, a touch module 34 on the main body 31, a first transmission interface for receiving the phone book data in the portable electronic product 7 and a second transmission interface 372 for recharging the portable electronic product 7. The first transmission interface 371 of the telephone device 3 is an infrared adaptor (IRDA), which is primarily in connection with the infrared module 38 to correspond to a portable electronic product 7 with infrared transmission function for performing infrared transmission and being able to download the phonebook data and display the status of the phonebook data by way of the display module.

The touch module 34 is arranged to have different block zones at the surface thereof with a plurality of number buttons 341 and other functional buttons 342 and it is possible to perform dialing the conventional telephone or executing other selected functions by way of touching the digital buttons or other functional buttons 342. Generally, the basic concept of the touch module 34 is different location of an object touching the touch module 34 can produce different corresponding control signals. As for the present embodiment, the arranged positions of the digital buttons 341 or other functional buttons 342 allocate a corresponding control signal respectively. The basic concept of the touch module 342 is not emphasized in the present invention and it is common to the persons who are skillful in the art so that no detail will be described further.

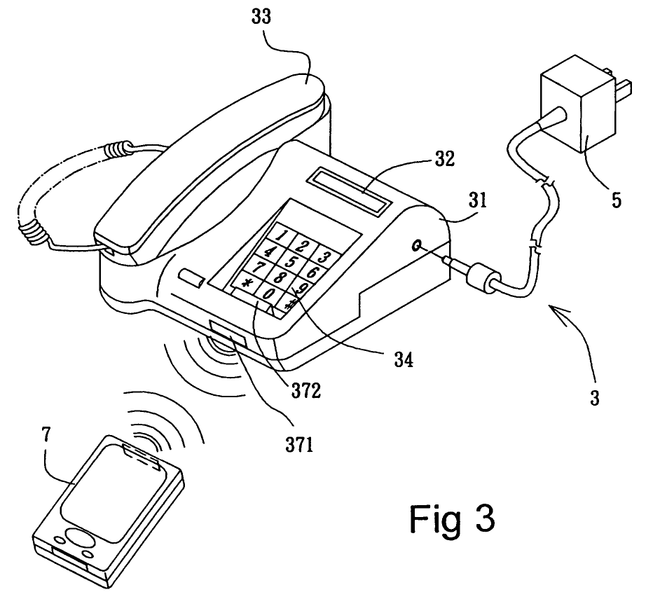

Referring to FIGS. 2 and 3, a controller 35, which electrically connects with the calling and receiving unit 33, a memory module 36, which is electrically connected to the controller 35, and a first transmission interface 371, which is electrically connected to the portable electronic product 7 are mounted in the telephone device 3. The telephone device 3 further electrically connects with a power supply 5 and the portable electronic product 7. The power supply 5 is used for converting the external power source and supplying charging power to the portable electronic product 7. The phonebook data 71 is stored in the portable electronic product for being available for the telephone device 3 downloading and saving in the memory module 36.

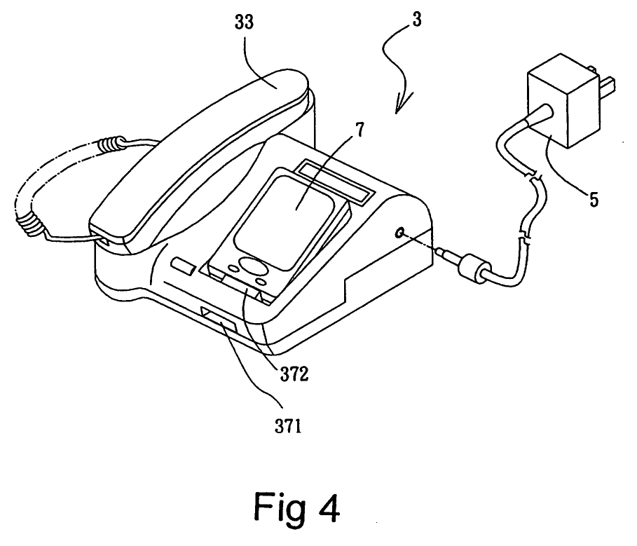

Referring to FIG. 4 in company with FIG. 2, the telephone device 3 in the present embodiment further includes a charging module 39, which is primarily to offer charging function for the second transmission interface 372 and electrically connects with the power supply 5 and the controller 35. The second transmission interface 372 is electrically connected to the controller 35 and the portable electronic product 7. The controller 35 utilizes the power from the power supply 5 to charge the portable electronic module 39 via the second transmission interface 372 by way of the charging module 39. Besides, the charging module 39 provides a function of voltage rise so that the voltage can be increased to 5V from 4.2V for being used by the controller 35.

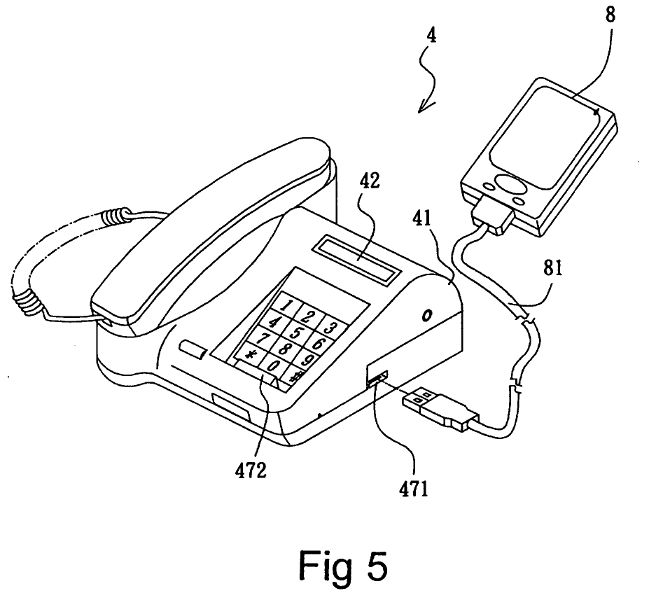

Referring to FIG. 5, the second embodiment of the telephone device capable of accessing phonebook of a portable electronic product according to the present invention provides a first transmission interface 471 in the a telephone device 4 and the first transmission interface 471 is USB connecting port, which corresponds to a USB module (not shown) mounted in a main body 41 of the telephone device 4. A USB transmission wire 81 can be used for connecting the portable product 8 with the first transmission interface 471 so as to perform download function of the phonebook data.

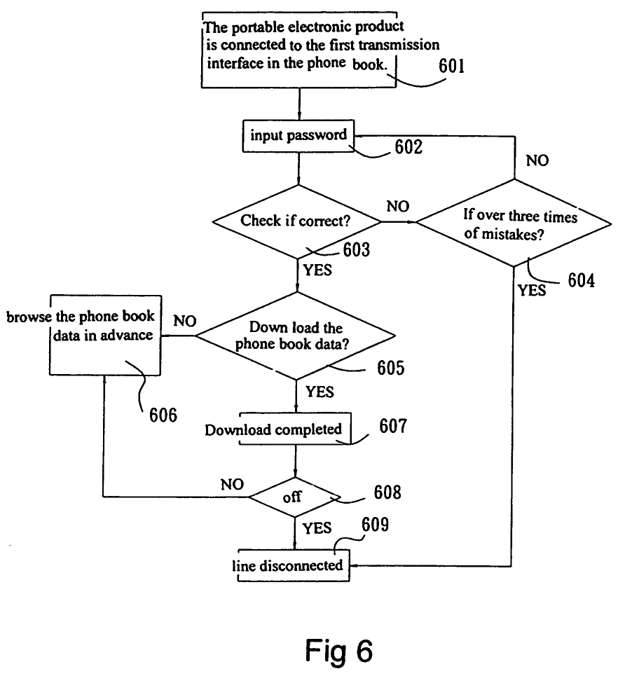

Referring to FIGS. 5 and 6, a method for reading the phonebook of a portable electronic product is illustrated. Firstly, step 601 is connecting a portable electronic product with USB transmission function is connected to the first transmission interface 471 with the USB transmission wire 81, i.e., the USB port. Then, step 602 is that the user inputs a password and step 603 is to check if the password is correct. In case of the password being correct, step 605 can be processed. Step 605 is the display module 42 displays if the phonebook data is going be download. In case of the password is incorrect, step 604 is processed. Step 604 is to count how many times of the input password, to prompt the user repeatedly and checking if the password is correct. If over three times of input errors have been counted, step 609 is executed. Step 609 is to terminate connection of the data transmission. If input errors are counted less than three times and it has been checked the correct password being input, step 605 is processed and the display module 42 displays if download of the phonebook is going to be performed. If it is confirmed, step 607 is processed to complete download function. In case of not downloading the phonebook data being decided and off line being selected in step 608, step 606 is executed and phonebook data is browsed on the display module 42. If it is selected to be off line in step 608, step 609 is executed to terminate the data transmission.

It is noted that the portable electronic product 7, 8 adapted to the telephone device 3, 4 in the preceding two embodiments can be a personal computer or laptop computer, which has the phonebook data being stored therein and provides an infrared receiver and a USB connecting port corresponding to the first transmission interface 371, 471 of the electronic product 7, 8 in addition to the cell phone or the personal digital assistant, which is capable of storing the phonebook data. Excepting the infrared receiver and USB connecting port for phonebook transmission, other types of data transmission such as wire or wireless transmission also can be used for connecting the telephone device 3, 4 to the portable electronic product 7, 8.

It is appreciated that the telephone device capable of reading phonebook of a portable electronic product according to the present invention includes the first transmission interface so that the telephone device can download phonebook data of the portable electronic product. Besides, the telephone device further includes the second transmission interface and the charging module for charging the portable electronic product. In order to enhance attraction of the operation interface, the touch type buttons are used instead of traditional press buttons for dialing the phone numbers. Further, the present invention provides a method of reading the phonebook data of a portable electronic product by way of a password being input and checked before the phonebook data being able to read so as to enhance security of the telephone device in use.

While the invention has been described with referencing to preferred embodiments thereof, it is to be understood that modifications or variations may be easily made without departing from the spirit of this invention, which is defined by the appended claims.

1. A telephone device capable of reading phonebook of a portable electronic product, being electrically connected to a power source and the portable electronic product and comprising:
a main body;
a display module;
a calling and receiving unit for receiving and sending voice message;
wherein, the main body further comprises:
a controller, being electrically connected to the calling and receiving unit and the display module;
a memory module, being electrically connected to the controller; and
a first transmission interface, being electrically connected to the controller;
characterized in that the controller receives phonebook data of the portable electronic product via the first interface, stores the phonebook data in the memory module and displays status of the phonebook data via the display module.

2. The telephone device capable of reading phonebook of a portable electronic product a defined in claim 1, wherein the first transmission interface is an infrared receiver associated with an infrared module to download the phonebook data of the portable electronic product via infrared transmission.

3. The telephone device capable of reading phonebook of a portable electronic product a defined in claim 1, wherein the first transmission interface is a USB connecting port associated with a USB module to download the phonebook data of the portable electronic product via USB transmission.

4. The telephone device capable of reading phonebook of a portable electronic product a defined in claim 1 further comprises a touch module mounted to the main body with a plurality of digital buttons arranged in different block zones to perform the ordinary dialing function via the digital buttons being touched.

5. The telephone device capable of reading phonebook of a portable electronic product a defined in claim 1 further comprises:
a recharging module, being electrically connected to the power source and the controller; and
a second transmission interface, being electrically connected to the controller and the portable electronic product;
wherein, power supplied by the charging module is utilized by the controller to recharge the portable electronic product via the second transmission interface.

6. The telephone device capable of reading phonebook of a portable electronic product as defined in claim 5, wherein the recharging module has a function of rising voltage.

7. A method for reading phonebook of a portable electronic product, using a telephone device, which is electrically connected to the portable electronic product and has a preset password stored therein, and comprising following steps:
(a) electrically connecting the telephone device to the portable electronic product;
(b) inputting a password, checking if the password being coincided with the preset password, processing step (c) in case of the password coinciding the preset password and processing step (d) in case of the password not coinciding the preset password;
(c) executing downloading phonebook data of the portable electronic product to the telephone device and processing step (e) once the downloading is finished;
(d) prompting the input password repeatedly and processing step (e) in case of password input exceeding three times; and
(f) disconnecting transmission of the phonebook data.

8. The method for reading phonebook of a portable electronic product as defined in claim 7 further comprises a step c-1, which is the phonebook data can be browsed after finishing downloading.
